(19) United States
(12) Patent Application Publication
(10) Pub. No.: US 2021/0008912 A1
(43) Pub. Date: Jan. 14, 2021

(54) TWO-SIDED STAMP

(71) Applicant: STAMPIN' UP! INC., Riverton, UT (US)

(72) Inventors: Andrea Bowden, Riverton, UT (US); Ashley Christensen, Riverton, UT (US); Sid Gray, Riverton, UT (US); Kevin Grymes, Riverton, UT (US); Brittani Holder, Riverton, UT (US); Brandon Homer, Riverton, UT (US); Emily Walker, Riverton, UT (US); Clyde Young, Riverton, UT (US)

(73) Assignee: STAMPIN' UP! INC., Riverton, UT (US)

(21) Appl. No.: 16/510,165

(22) Filed: Jul. 12, 2019

(51) Int. Cl. B41K 1/04

(52) U.S. Cl. CPC B41K 1/04

(57) ABSTRACT

A two-sided stamp and method of using and manufacturing the same. The two-sided stamp comprises a first stamping surface and a second stamping surface. The first stamping surface is capable of transferring a quantity of ink from an ink source to an article to be stamped. The first stamping surface can also include one or more openings. The second stamping surface is likewise capable of transferring a quantity of ink from an ink source to an article to be stamped. The second stamping surface can also include one or more openings. The openings in the first flat surface and the openings in the second flat surface can be continuous and extend between the first stamping surface and the second stamping surface.

### BACKGROUND

In crafting, stamps are widely used to apply designs, lettering and other images to an article. A typical stamp includes a base and a raised stamping surface of substantially uniform height. The stamp can be affixed to a handle or some other stamping tool such as a stamp press. In operation, a user would apply ink to the stamping surface. This is usually done by pressing the stamp into an ink source such as an inkpad, though one could simply apply the ink directly to the stamping surfaces with a cloth or brush or sponge or other applicator. Once the stamping surface has ink applied, the stamp is pressed onto an article to be stamped. Typical articles that can be stamped include but are not limited to paper, cardboard, wood, glass and metal.

Photopolymer stamps are a popular style of stamp characterized by durability but also flexibility that can be utilized in a wide variety of applications. A typical photopolymer stamp has a stamping surface on one side and a flat surface on the other side that can be tacky enough to permit it to stick to a surface such as a stamp press. The stamping surface is a raised design comprising a series of ridges and protrusions that, when pressed to a stamping pad, retain the ink that is then applied to an article when the stamp is pressed on it. Photopolymer stamps also will typically have a foot or base. The foot or base is typically an edge around the raised design that loosely corresponds to the shape of the raised design. Examples of prior art photopolymer stamps 100 are illustrated in FIGS. 1(a)-(d) with the stamping surface depicted at 102, the raised design at 104, the foot at 106 and the flat surface on the opposite side at 108.

The method of manufacturing a photopolymer stamp in a typical case is set forth below. A photopolymer plate is made utilizing an exposure unit such as a Merigraph Exposure Unit type 30.40 sold by Hercules Incorporated (Wilmington, Del.). Referring to FIG. 2, in preparation for making the plate, a negative 110 is placed on the unit. A protective film 112 is placed over the negative 110 and any air bubbles are removed. A liquid photopolymer 114 is poured over the protective film 112 and a substrate 116 is placed over the photopolymer 114. Ultraviolet (UV) light 118 from the bottom selectively passes through the bottom negative 110 and through the protective film 112 to reach the unreacted photopolymer 114. The photopolymer 114 reacts to UV light 118 and hardens to create the stamping surface design.

UV light 118 from the top also passes through the substrate 116 to reach the unreacted photopolymer 114. The photopolymer 114 similarly reacts to top UV light 118 and hardens. Since the UV light 118 is not selectively directed to the photopolymer 114 (i.e. through a negative), it creates essentially a uniform and substantially flat sheet of hardened photopolymer on the top surface known as the stamp floor.

The protective film 112, photopolymer 114 and substrate 116 are then removed from the exposure unit. Any remaining unreacted photopolymer can be reclaimed through known reclaim techniques such as a Merigraph Reclaim Board 30.40 sold by Hercules Incorporated (Wilmington, Del.). The plate is then washed, rinsed, dried and cut. A coversheet 109 (FIG. 1(d)) may also be placed over the photopolymer. The result is a one-sided stamp with a foot as depicted in FIGS. 1(a)-(d).

However, in certain circumstances, a stamper will want to have mirrored images of a design. Traditionally, to do so would either require two different stamps with identical images oriented in opposite directions or, alternatively, a stamper could utilize the practice of “mirroring.” Mirroring involves stamping an image onto the desired surface and then stamping the same image onto a plain, flat piece of photopolymer. The flat photopolymer piece is then pressed onto the desired surface transferring the ink onto that surface in the mirror image of the original design.

The problem with the mirroring technique is that it does not allow for a clean, crisp image because the ink is prone to smearing and smudging. Utilizing two different stamps can help address this issue. However, such an approach is more expensive as it requires a user to purchase two separate stamp designs wherever a mirrored image is desired. This requires additional storage space. There is also a higher likelihood that the two stamps will not be dimensionally identical simply due to slight variations at the manufacturing level. Moreover, mirror-image stamps are generally not even offered by stamp manufacturers.

The present invention in its various embodiments has addressed all of the foregoing issues. The present invention provides a photopolymer stamp that has a first stamping design on one side and a second stamping surface on the opposite side. In some embodiments, the first and second stamping surfaces are mirror images of the same design. In other embodiments, the first and second stamping images are different designs. In both cases, the two-sided stamp has removed or substantially removed the foot.

### SUMMARY

The present invention in its various embodiments is a two-sided stamp and method of using and manufacturing the same. The two-sided stamp comprises a first stamping surface and a second stamping surface. The first stamping surface is capable of transferring a quantity of ink from an ink source to an article to be stamped. The first stamping surface can also include one or more openings. The second stamping surface is likewise capable of transferring a quantity of ink from an ink source to an article to be stamped. The second stamping surface can also include one or more openings. The openings in the first flat surface and the openings in the second flat surface can be continuous and extend between the first stamping surface and the second stamping surface. The method of creating mirrored stamp images comprises the provision of a two-sided stamp. The two-sided stamp includes a first stamping surface and a second stamping surface. The first stamping surface has one or more first flat surfaces capable of transferring ink from an ink source to an article to be stamped. The second stamping surface likewise has one or more second flat surfaces capable of transferring ink from an ink source to the article to be stamped. Both stamping surfaces can include one or more openings in the flat surfaces. Ink is applied to the first flat surface which ink is then deposited on the article to be stamped. The stamp is reversed and ink is applied to the second flat surface and then similarly deposited on the article to be stamped creating mirrored stamp images.

Manufacturing a two-sided stamp, according to one embodiment of the present invention, comprises the steps of placing a first negative over a first UV light source. The first negative has a UV-permeable section and a UV-impermeable section. A protective film can be placed over the first negative. A liquid photopolymer is then deposited over the protective film. A substrate can then be placed over the liquid photopolymer followed by a second negative. The second negative similarly has a UV-permeable section and a UV-impermeable section. A second UV light source is placed over the second negative. The first and second UV light sources are illuminated. As the UV light passes through the UV-permeable sections of the first and second negative it reacts the liquid photopolymer causing it to harden into a stamp with stamping surfaces on both sides. The unreacted portion of the liquid photopolymer can then be removed and the two-sided stamp washed and optionally washed again.

### BRIEF DESCRIPTION OF THE DRAWINGS

FIGS. 1(a), 1(b), 1(c) and 1(d) are examples of one-sided stamps as can be found in the prior art.

FIG. 2 illustrates the composition of a photopolymer exposure plate as practiced in the prior art.

FIG. 3 is a depiction of a two-sided stamp first side according to one embodiment of the present invention.

FIG. 4 is a depiction of a two-sided stamp second side according to one embodiment of the present invention.

FIG. 5 is a depiction of a two-sided stamp first side according to one embodiment of the present invention.

FIG. 6 is a depiction of a two-sided stamp second side according to one embodiment of the present invention.

FIG. 7 illustrates the composition of a photopolymer exposure plate according to one embodiment of the present invention.

FIG. 8 is a depiction of a mirrored image stamped surface according to one embodiment of the present invention.

FIG. 9 is a portion of an example of a first negative according to one embodiment of the present invention.

FIG. 10 is a portion of an example of a second negative according to one embodiment of the present invention.

FIG. 11 is a depiction of a two-sided stamp having different images on opposite sides according to one embodiment of the present invention.

FIG. 12 is a depiction of stamped images from the stamp in FIG. 11 reflecting the different images produced by the opposite sides.

FIG. 13 is a depiction of a two-sided stamp having different images on opposite sides according to one embodiment of the present invention.

FIG. 14 is a depiction of stamped images from the stamp in FIG. 11 reflecting the different images produced by the opposite sides.

FIG. 15 is a portion of an example of a first negative according to one embodiment of the present invention.

FIG. 16 is a portion of an example of a second negative according to one embodiment of the present invention.

FIG. 17 is a portion of an example of a first negative according to one embodiment of the present invention.

FIG. 18 is a portion of an example of a second negative according to one embodiment of the present invention.

FIG. 19 illustrates the application of ultraviolet (UV) light to a photopolymer exposure plate according to one embodiment of the present invention.

FIG. 20 illustrates the application of ultraviolet (UV) light to a photopolymer exposure plate according to one embodiment of the present invention.

FIG. 21 is an illustration of a series of stamps having a stamping surface on one side and, on the opposite side a plain, flat surface.

FIG. 22 is an illustration of the imagery created by the respective sides of the stamps depicted in FIG. 21.

### DESCRIPTION OF ILLUSTRATED EMBODIMENTS

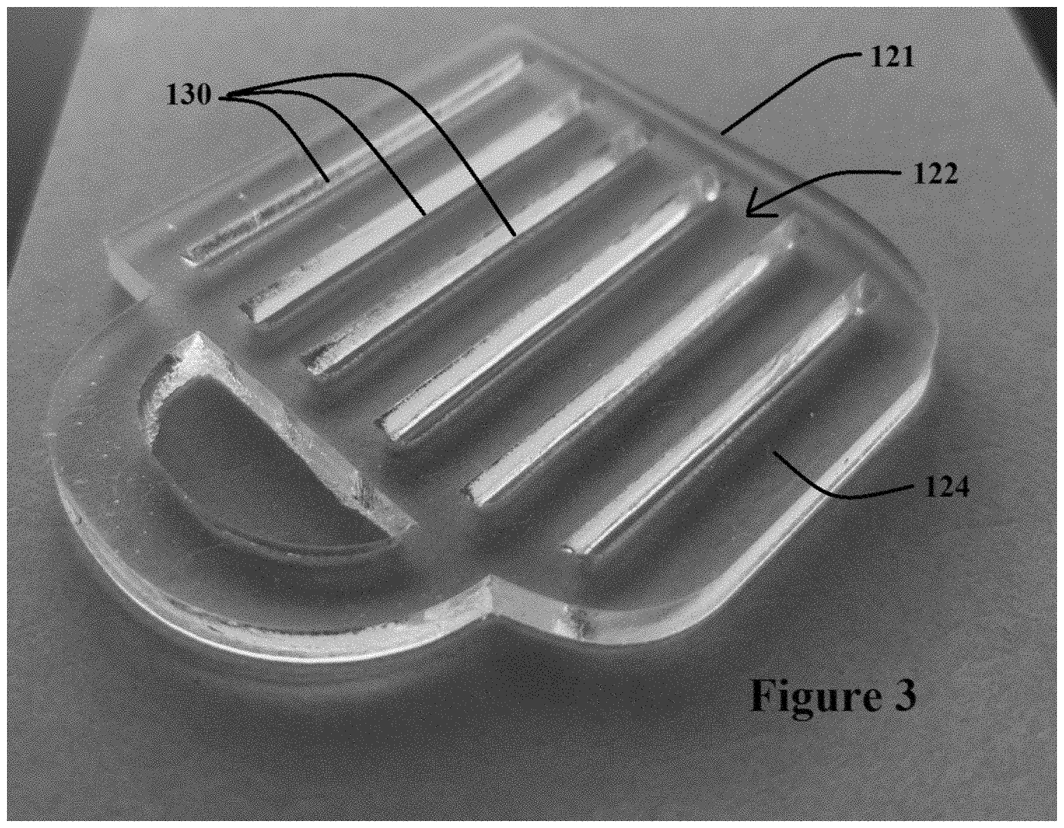

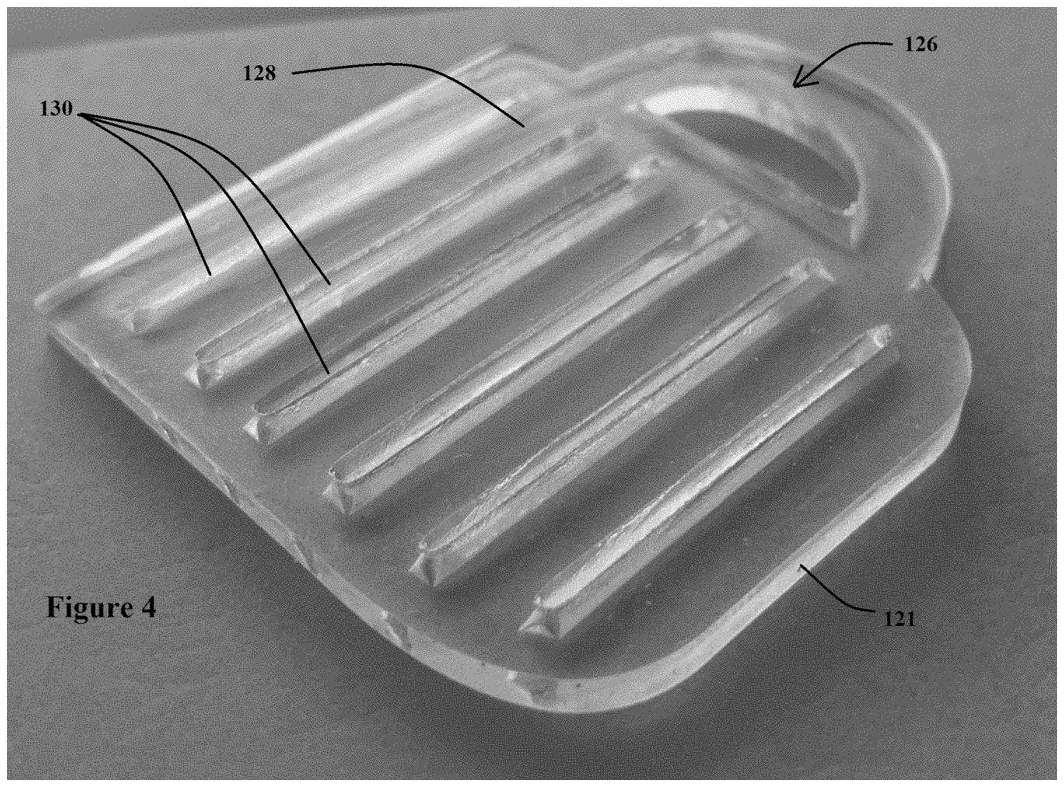

Referring to FIGS. 3-4, a two-sided stamp 121 is shown according to one embodiment of the present invention. FIG. 3 shows a first stamping surface 122. The first stamping surface 122 is in the shape of a striped mug 124. It is noted that, unlike prior art stamps where the stamping surface is a raised design comprising a series of ridges and protrusions as discussed above, the present stamp instead utilizes flat surfaces to apply the ink. Recesses or openings such as the grooves 130 serve as breaks in the ink when applied to the article being stamped. In the illustrated embodiment, grooves 130 extend through the entirety of the stamp 121. FIG. 4 shows a second stamping surface 126 that is on the opposite side of the first stamping surface 122. Second stamping surface 126 is similarly a striped mug 128. The striped mug 128 is a mirrored image of the striped mug 124 of the first stamping surface 122. Advantageously, both stamping surfaces 122, 126 can be tacky, allowing either side to serve as a stamping surface or as the interface with a stamping press or other application means. The absence of ridges in this particular design makes it especially well suited for such use.

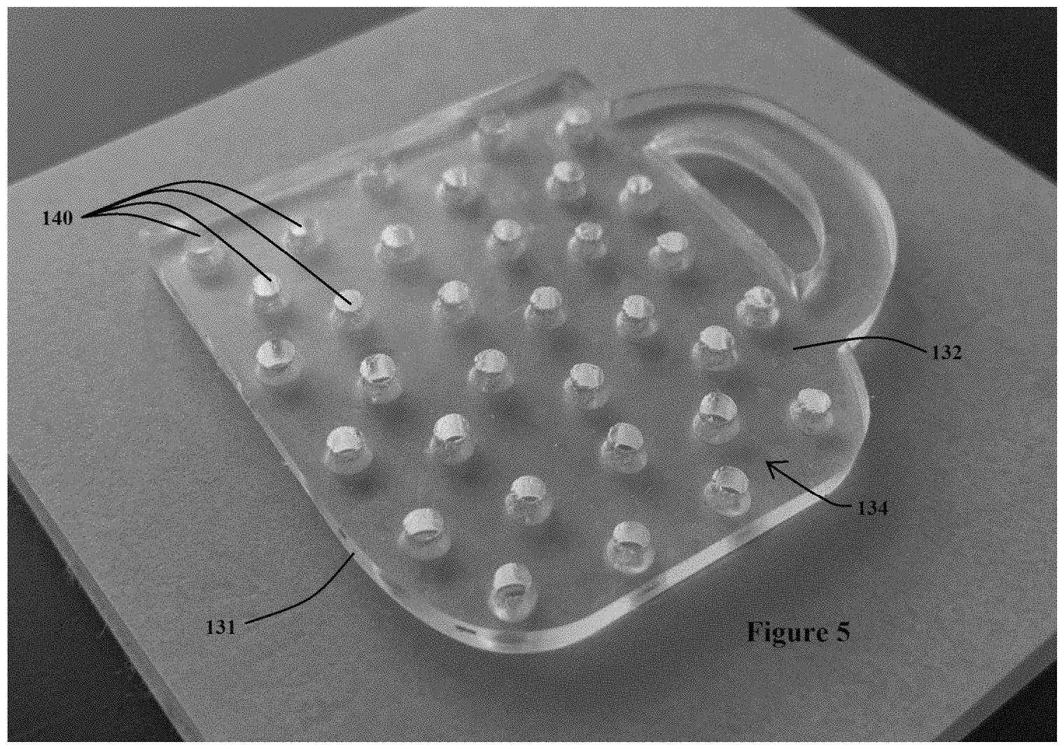

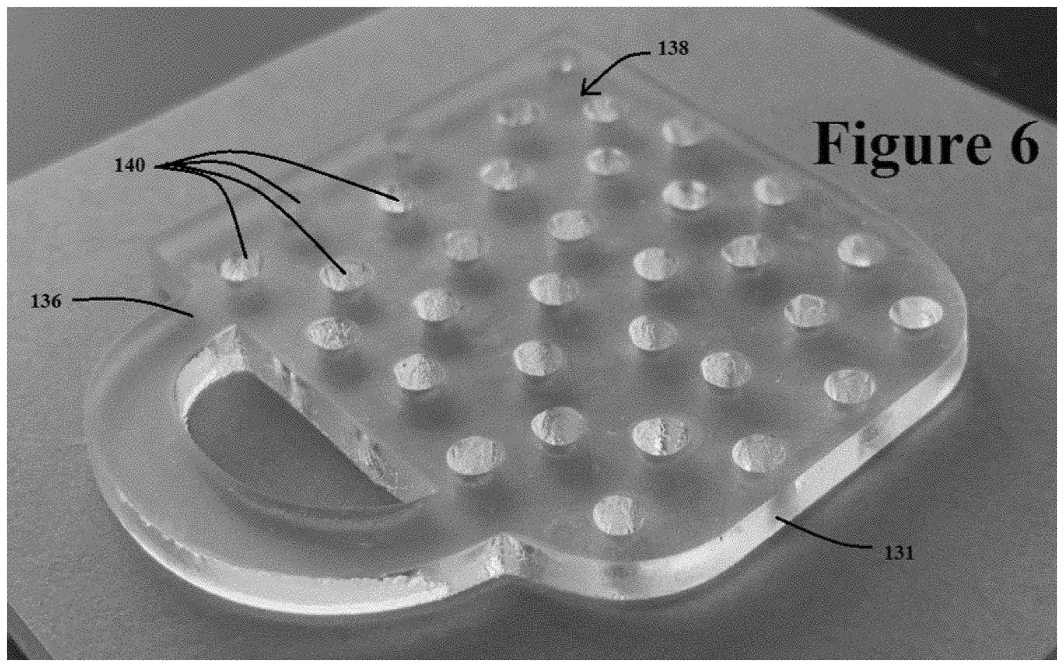

Similarly, FIGS. 5 and 6 depict a two-sided stamp 131 according to one embodiment of the present invention. FIG. 5 shows another first stamping surface 132. The first stamping surface 132 is in the shape of a spotted mug 134. Again, unlike prior art stamps where the stamping surface is a raised design comprising a series of ridges and protrusions as discussed above, the present stamp instead utilizes flat surfaces to apply the ink. Recesses or openings such as the holes 140 serve as breaks in the ink when applied to the article being stamped. In the illustrated embodiment, holes 140 extend through the entirety of the stamp 131. FIG. 6 shows a second stamping surface 136 that is on the opposite side of the first stamping surface 132. Second stamping surface 136 is similarly a spotted mug 138. The spotted mug 138 is a mirrored image of the spotted mug 134 of the first stamping surface 132.

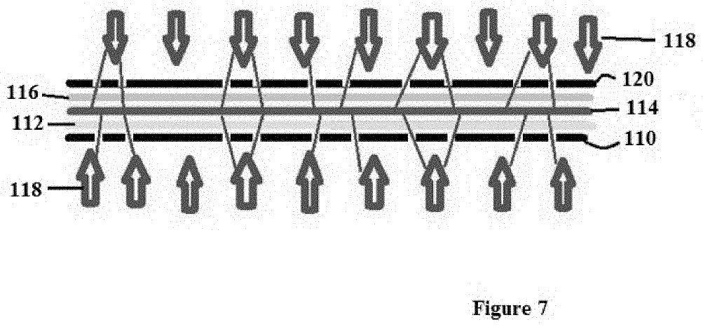

Referring to FIG. 7, the method of manufacturing a two-sided photopolymer stamp according to one embodiment of the present invention is as follows. A photopolymer plate is made utilizing an exposure unit such as a Merigraph Exposure Unit type 30.40 sold by Hercules Incorporated (Wilmington, Del.). In preparation for making the plate, a first negative 110 is placed on the exposure unit. A protective film 112 is placed over the first negative 110 and any air bubbles are removed. A liquid photopolymer 114 is poured over the protective film 112 and a substrate 116 is placed over the polymer 114. Suitable substrates 116 include but are not limited to 7 mm clear acetate sheet plastic. Suitable photopolymers 114 include but are not limited to known liquid photopolymers for stamping/printing press plates such as polyurethane methacrylate oligomer and methacrylic esters based liquid photopolymers. A second negative 120 is then placed over the substrate 116.

Ultraviolet (UV) light 118 from the bottom selectively passes through the first negative 110 and through the protective film 112 to reach the unreacted polymer 114. The polymer 114 reacts to UV light 118 and hardens to form the first stamping surface design (e.g. 132).

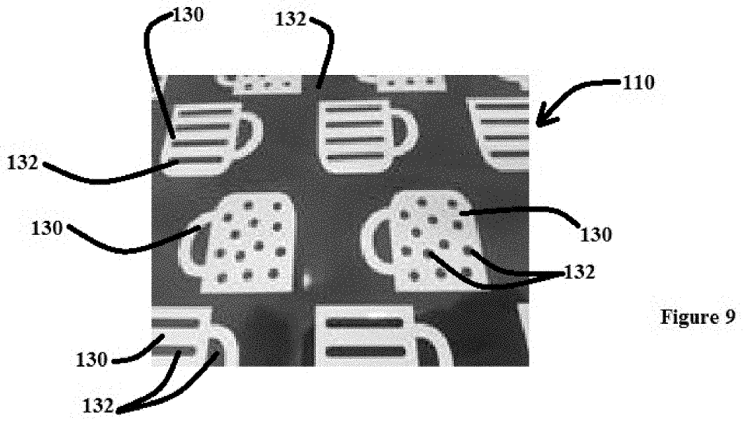

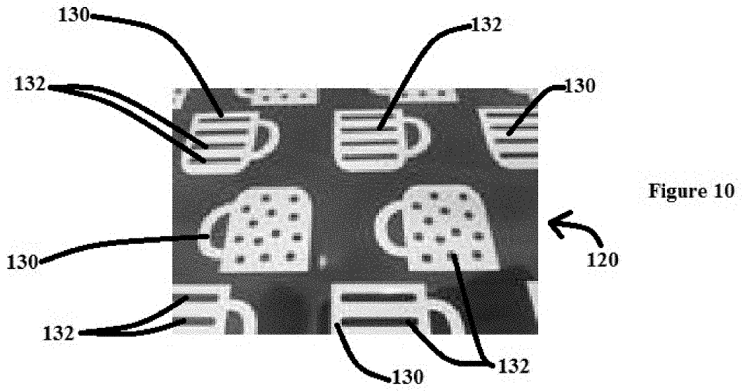

UV light 118 from the top also selectively passes through the second negative 120 and the substrate 116 to reach the unreacted polymer 114. The polymer 114 similarly reacts to top UV light 118 and hardens to form the second stamping surface (e.g. 136). As noted below in connection with FIGS. 9 and 10, both the first and second negatives 110, 120 contain UV-permeable sections 130 and UV-impermeable sections 132. The UV light is able to pass through the UV-permeable sections 130 of the negatives 110, 120 which are depicted as breaks in the negatives 110, 120 in FIG. 7.

As further discussed below, the exposure of the UV light 118 could be staggered such that the top exposure is followed by the bottom exposure or vice versa. Alternatively, in yet other embodiments, the top and bottom exposures could occur substantially simultaneously.

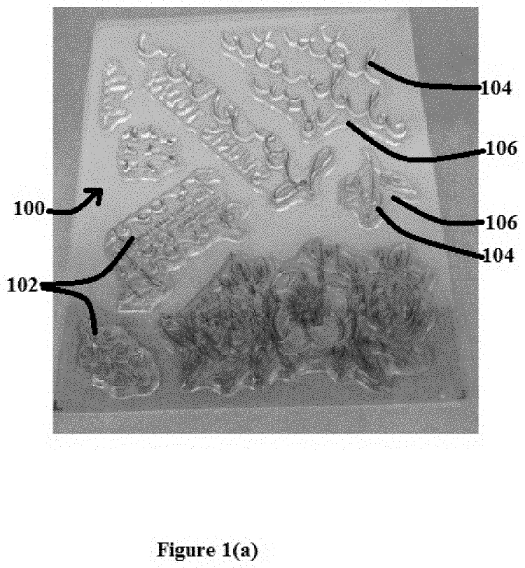

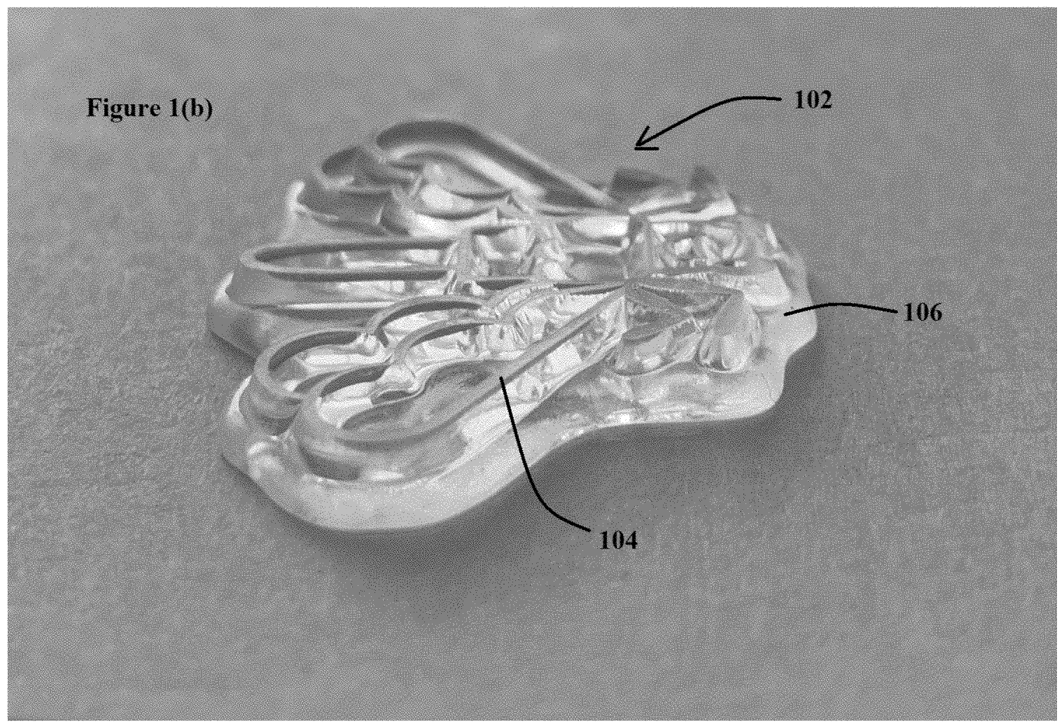

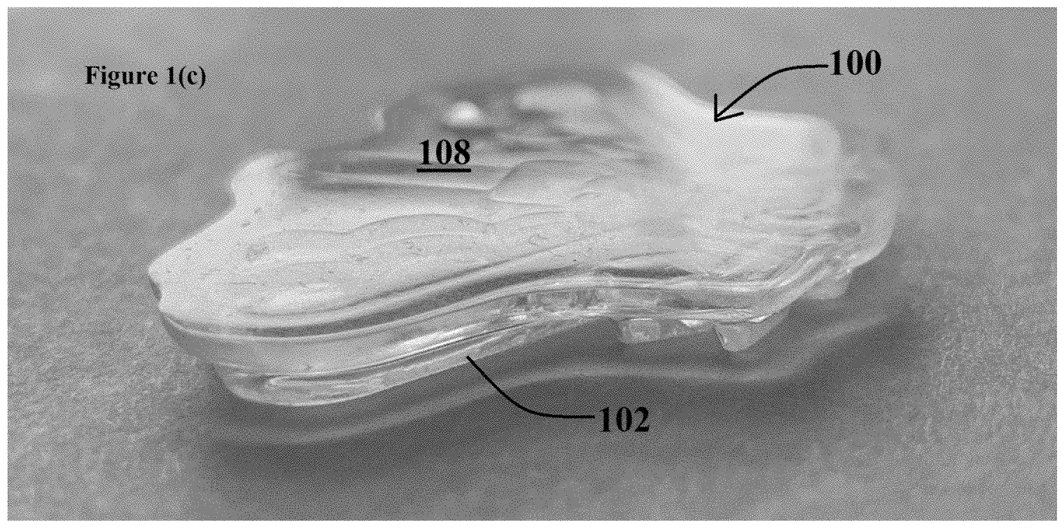

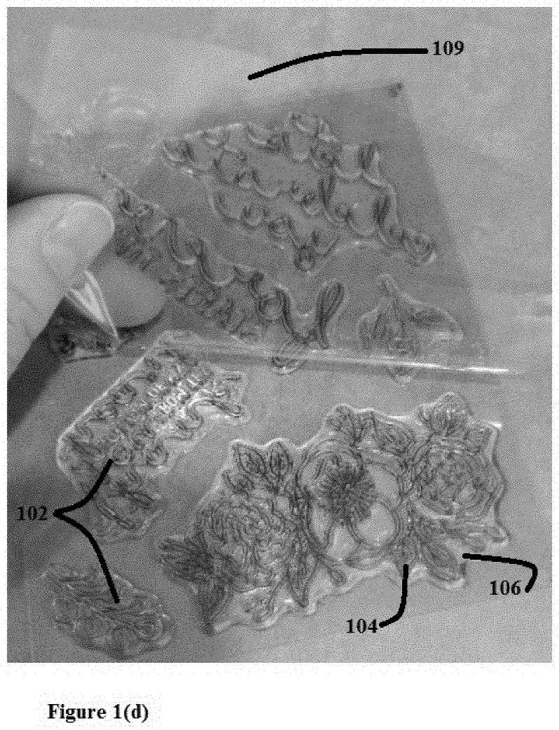

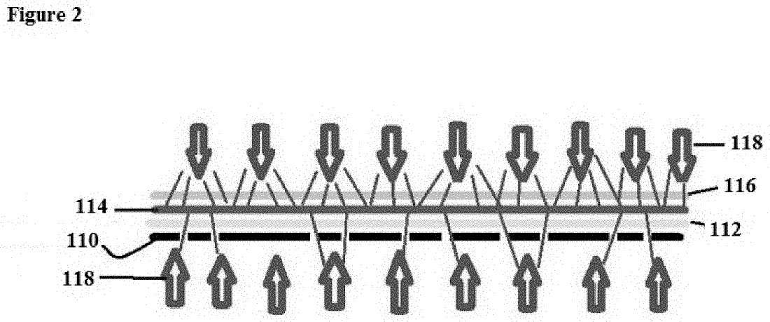

The protective film 112, polymer 114 and substrate 116 are then removed from the exposure unit. Any remaining unreacted polymer can be reclaimed through known post-exposure techniques such as a Merigraph Reclaim Board 30.40 sold by Hercules Incorporated (Wilmington, Del.). The plate is then washed, rinsed, dried and cut according to known photopolymer stamp production techniques. However, in certain circumstances, subsequent rounds of washing will be utilized. This can be particularly important to flush out any residual unreacted photopolymer in areas such as grooves 130 or holes 140. A coversheet (similar to 109 in FIG. 1(d)) may also be placed over the photopolymer. Coversheets can again be 7 mm clear acetate sheet plastic or other known suitable substances. The result is a two-sided stamp.

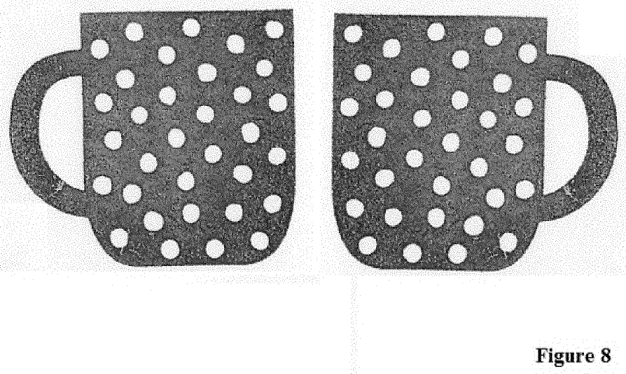

FIG. 8 is an illustration of the mirror-imagery that can be accomplished with a two-sided stamp with expressions of both sides of a stamp being depicted next to one another.

FIGS. 9 and 10 illustrate a first and second negative 110, 120 respectively according to one embodiment of the present invention where the end product is a stamp having mirrored stamp designs of the same image on opposite sides. The first negative 110 and the second negative 120 are largely duplicates of each other. When placed on the exposure machine, the negatives 110, 120 are positioned so their UV-permeable sections are substantially aligned. Thus, the same pattern of UV light is reaching the photopolymer 114 from both top and bottom directions.

This method then allows unreacted photopolymer, i.e. photopolymer that is not exposed to UV light, to be extracted from common openings that extend from the first stamping surface (122, 132) through the stamp 121, 131 to the second stamping surface (126, 136) such as the grooves 130 and holes 140.

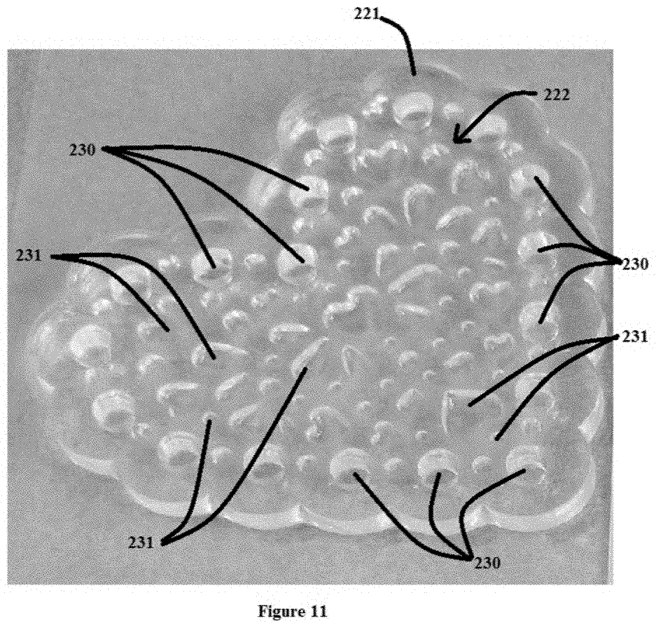

Referring now to FIG. 11, a two-sided stamp 221 is shown according to yet another embodiment of the present invention. The first stamping surface 222 is in the shape of a decorated heart. Again, unlike prior art stamps where the stamping surface is a raised design comprising a series of ridges and protrusions as discussed above, the present stamp instead utilizes flat surfaces to apply the ink. Recesses or openings 230 serve as breaks in the ink when applied to the article being stamped. In the illustrated embodiment, some openings 230 extend through the entirety of the stamp 221 from the first stamping surface 222 to the opposite stamping surface. However, other openings or holes 231 are only on a single side thus allowing for the opposite sides of the stamp 221 to create different stamp designs. As with other embodiments discussed herein, both stamping surfaces can be tacky, allowing either side to serve as a stamping surface or as the interface with a stamping press or other application means.

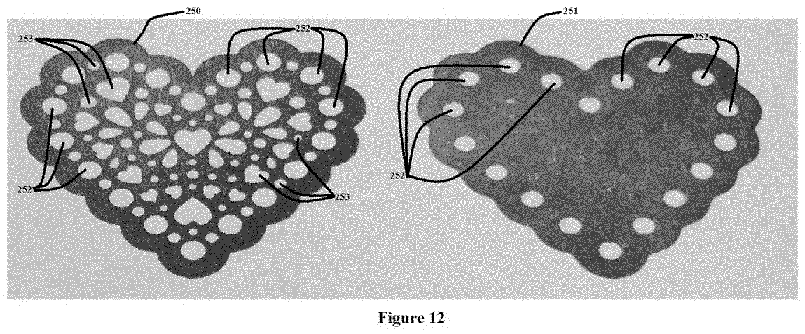

FIG. 12 is an illustration of the different stamping designs that can be accomplished with the two-sided stamp 221 of FIG. 11 with expressions of both sides being depicted next to one another 250, 251. As can be noted, the first stamped design 250 has elements 252 that correspond to openings 230 in both images. However, elements 253 that correspond with partial openings or holes 231 are only visible on a single side. It is however noted that partial openings 231 and corresponding elements 253 could in certain embodiments occur on either or both sides of the stamp 221. The key distinction between openings 230 and partial openings 231 is that partial openings 231 do not extend all the way through the stamp 221.

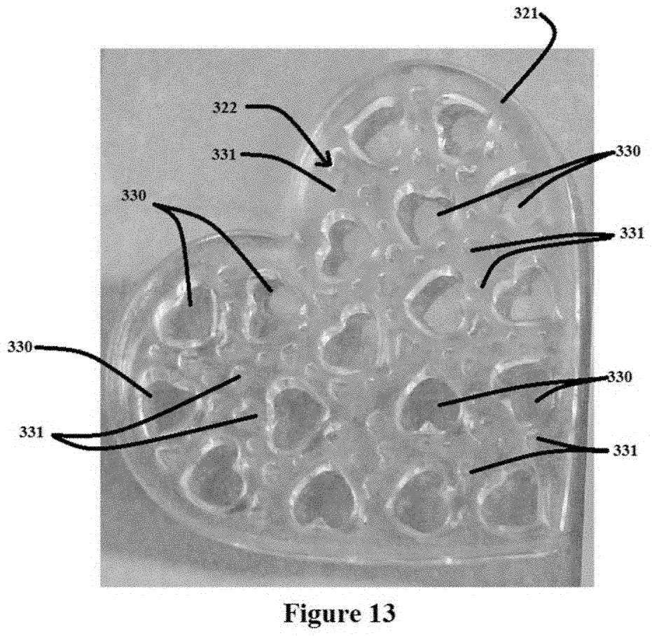

FIG. 13 depicts a two-sided stamp 321 according to yet another embodiment of the present invention. Again, the first stamping surface 322 is in the shape of a decorated heart. The present stamp utilizes flat surfaces to apply the ink with recesses or openings 330 serving as breaks in the ink when applied to the article being stamped. Again, in the illustrated embodiment, some openings 330 extend through the entirety of the stamp 321 from the first stamping surface 322 to the opposite stamping surface. However, other openings 331 are only on a single side thus allowing for the opposite sides of the stamp 321 to create different stamp designs. As with other embodiments discussed herein, both stamping surfaces can be tacky, allowing either side to serve as a stamping surface or as the interface with a stamping press or other application means.

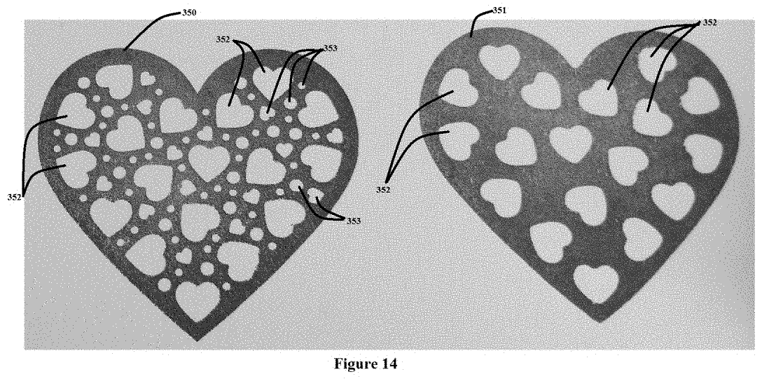

FIG. 14 is an illustration of the different stamping designs that can be accomplished with the two-sided stamp 321 of FIG. 13 with expressions of both sides being depicted next to one another 350, 351. Again, the first stamped design 350 has elements 352 that correspond to openings 330 in both images 350, 351. However, elements 353 that correspond with partial openings 331 are only visible on a single side 350. Again, partial openings 331 could occur on either or both sides of the stamp 321 in various embodiments.

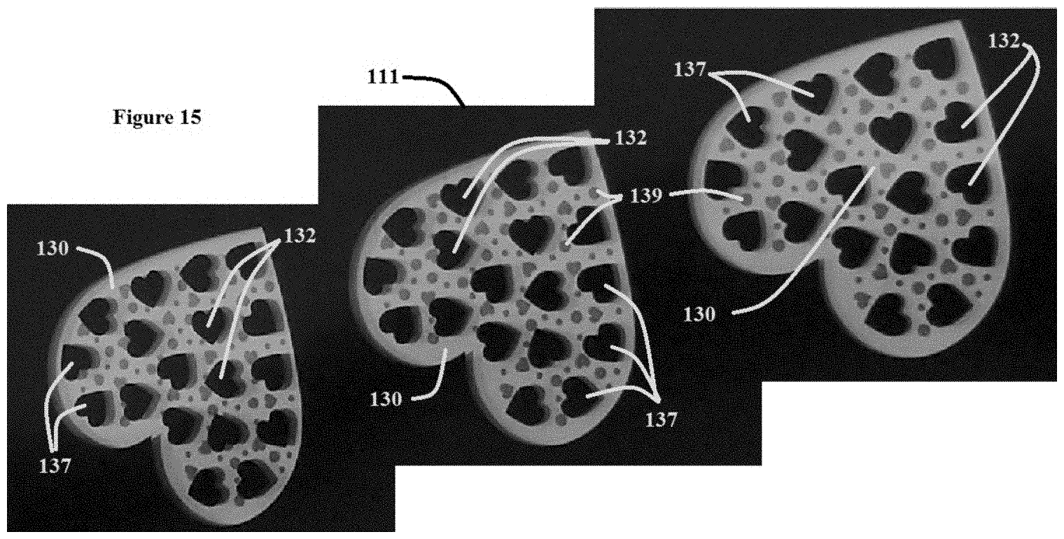

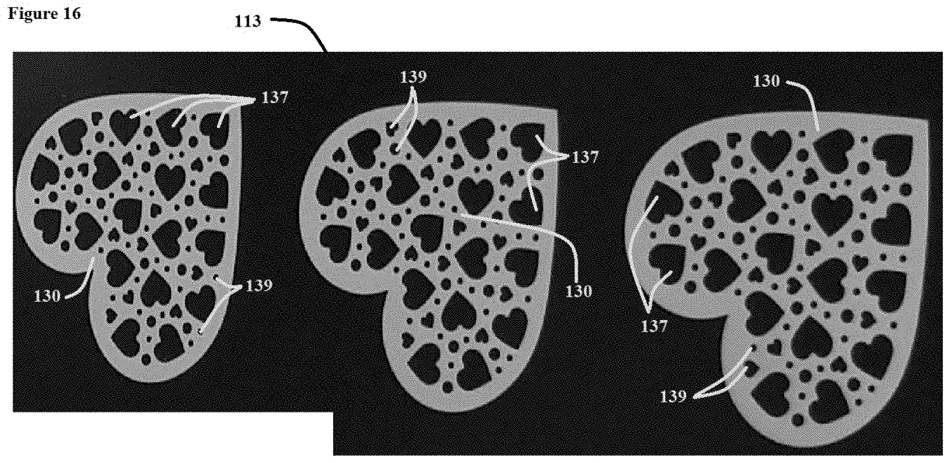

FIGS. 15 and 16 illustrate a first and second negative 111, 113 respectively according to one embodiment of the present invention where the end product is a stamp having different stamp designs images on opposite sides as discussed above. In the illustrated embodiment, FIG. 15 corresponds to the top negative and FIG. 16 corresponds to the bottom negative in the manufacturing process. In one embodiment of the process, the exposure of UV light through the top negative is what creates the floor of the stamp.

Similar to negatives 110, 120, each negative 111, 113 contains UV-permeable sections generally at 130 and UV-impermeable sections generally at 132. The UV-permeable sections 130 allow UV light to pass through where the UV-impermeable sections 132 do not permit UV light to pass through in any substantial way.

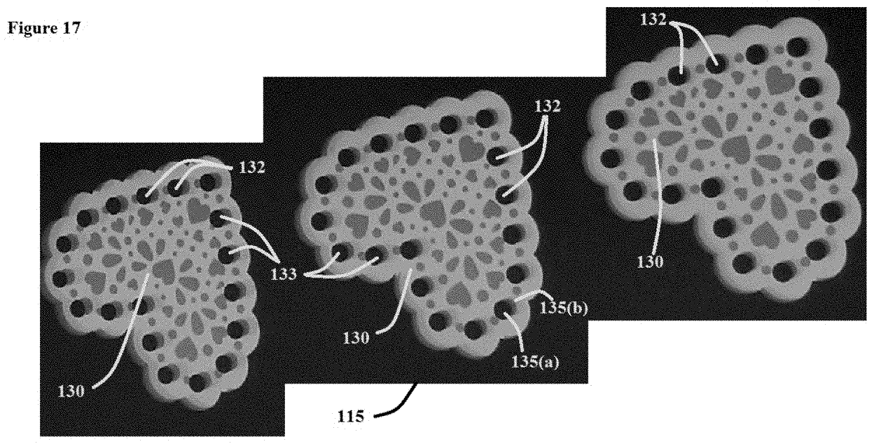

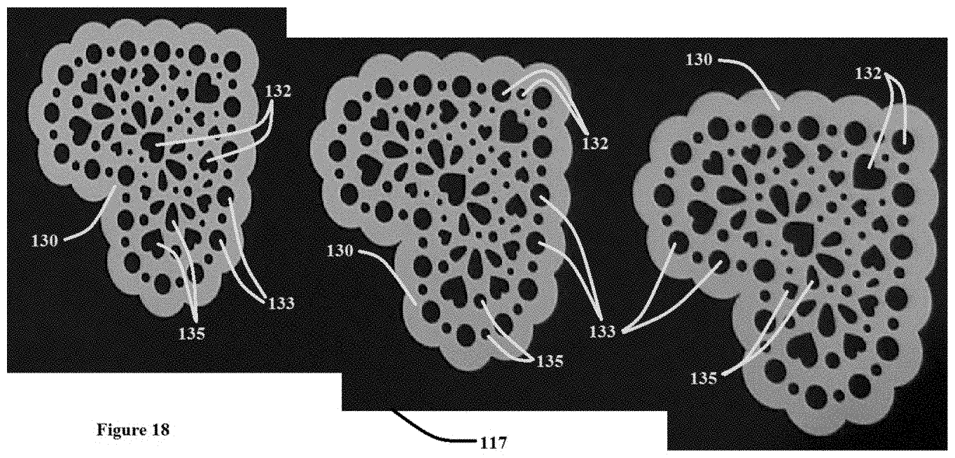

FIGS. 17 and 18 similarly illustrate a first and second negative 115, 117 respectively according to one embodiment of the present invention where the end product is a stamp having different stamp designs images on opposite sides as discussed above. In the illustrated embodiment, FIG. 17 corresponds to the top negative and FIG. 18 corresponds to the bottom negative in the manufacturing process. In one embodiment of the process, the exposure of UV light through the top negative is what creates the floor of the stamp.

Again, each negative 115, 117 contains UV-permeable sections generally at 130 and UV-impermeable sections generally at 132. The UV-permeable sections 130 allow UV light to pass through where the UV-impermeable sections 132 do not permit UV light to pass through in any substantial way.

The two-sided stamp 221 depicted in FIG. 11 has a first stamping surface 222 that corresponds to negative images 117 (FIG. 18) and an opposite stamping surface that corresponds with negative image 115 (FIG. 17). Openings 230 in the two-sided stamp 221 that extend through the entirety of the stamp 221 from the first stamping surface 222 to the opposite stamping surface are created by the circular UV-impermeable sections 133 around the perimeter of the heart shape and that are common to both the first and second negative 115, 117. Openings 231 that are only on a single side are created by UV-impermeable sections 135 that are only on one of the negatives.

In the illustrated embodiment, UV-impermeable sections 135 are seen in FIG. 18 on negative 117. However, UV-impermeable sections 135 are also visible through negative 115 in FIG. 17 even though they are not actually on the negative. In particular, FIG. 17 shows negatives 115, 117 aligned and stacked as they would be in the manufacturing process according to one embodiment of the present invention. As such, the UV-impermeable sections 135 of negative 117 are visible through the UV-permeable sections 130 of negative 115.

FIG. 17 also illustrates how, in some circumstances, the present method allows the alignment of UV-impermeable sections 135 (and correspondingly the alignment of the UV-permeable sections 130) to be inexact. In particular, as seen at 135(a) and 135(b), the UV-impermeable sections do not exactly match up but are still suitable for generating the stamps as discussed herein. However, in other embodiments, more exact matching may be desirable and both are considered within the scope of the present invention.

The two-sided stamp 321 depicted in FIG. 13 also has a first stamping surface 322 that corresponds to negative images 113 (FIG. 16) and an opposite stamping surface that corresponds with negative image 111 (FIG. 15). Openings 330 in the two-sided stamp 321 that extend through the entirety of the stamp 321 from the first stamping surface 322 to the opposite stamping surface are created by the circular UV-impermeable sections 137 around the perimeter of the heart shape and that are common to both the first and second negative 111, 113. Openings 331 that are only on a single side are created by UV-impermeable sections 139 that are only on one of the negatives. Again, UV-impermeable sections 139 are shown in FIG. 16 on negative 113. However, as discussed previously, they can also be seen in FIG. 15 visible through negative 111 even though they are not actually on the negative.

The method of manufacturing stamps with different stamping surfaces on opposite sides is closely similar to the method set forth above and outlined in FIG. 7. However, one notable difference is the importance of the exposure timing and the orientation of the exposure. In particular, as UV light contacts the liquid photopolymer, the photopolymer reacts to the UV light and hardens. This hardening typically takes place incrementally. In other words, the depth of the hardening depends largely on the amount of time the liquid photopolymer is exposed to the UV light source. The longer the duration, the more deeply the reaction will take place. In contrast, a shorter exposure to the UV light source will result in a shallower reaction.

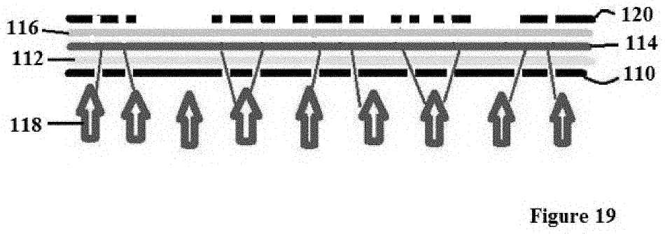

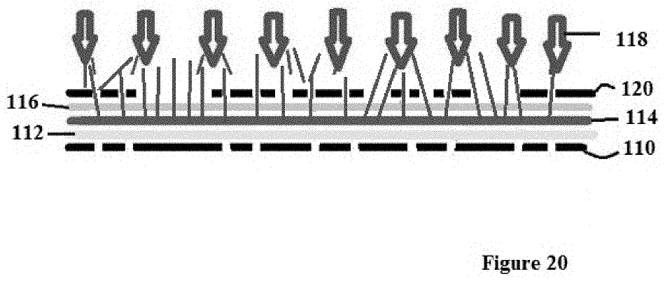

To illustrate, referring to FIG. 19, a photopolymer plate is made utilizing an exposure unit as discussed above. In preparation for making the plate, a first negative 110 is placed on the exposure unit. A protective film 112 is placed over the first negative 110. A liquid photopolymer 114 is poured over the protective film 112 and a substrate 116 is placed over the polymer 114. A second negative 120 is then placed over the substrate 116. UV light 118 from the bottom selectively passes through the first negative 110 and through the protective film 112 to reach the unreacted polymer 114. The UV light is left on for a predetermined amount of time during which time polymer 114 reacts to UV light 118 and hardens to a depth determined by the duration of time the photopolymer is exposed to the UV light. The bottom UV light is then turned off and the top UV light is applied for a predetermined amount of time as depicted in FIG. 20. Again, the polymer 114 reacts to UV light 118 and hardens to a depth determined by the duration of time the photopolymer is exposed to the UV light.

It is noted that in all manufacturing processes discussed herein, it is not necessary for the UV light to come from a particular direction in order to accomplish the purposes of the invention. For example, in certain embodiments, the UV light from the bottom is used first followed by the UV light from the top. In yet other embodiments, the top and bottom UV light exposure will take place substantially simultaneously. It is also noted that while terms “top” and “bottom” are used for ease of reference, such terms are not intended to limit the scope of the present invention to a particular orientation of the UV light sources. Rather, any opposing UV light sources could apply where applicable.

By directing UV light through differing top and bottom negatives and by limiting the duration of UV light exposure, the photopolymer on one side will be hardened and the photopolymer on the opposite side will remain unreacted and can be removed by techniques previously discussed. The result is a two-sided stamp 221, 321 (FIGS. 11, 13) having openings 230, 330 that extend through the entirety of the stamp 221, 321 and openings 231, 331 that are only on a single side. Such a two-sided stamp 221, 321 can thereby create a first stamped design 250, 350 having elements 253, 353 that correspond with partial openings 231, 331 on a single side 250, 350 and elements 252, 352 on both sides (FIGS. 12, 14).

For a stamp of approximately 0.120 inches in thickness, a typical exposure duration would be sixty seconds for the top exposure and sixty seconds for the bottom exposure. This generates polymer growth of approximately 0.060 inches with each exposure. In yet other embodiments, a seventy second exposure for both the top and bottom UV light sources is preferred. A longer exposure period is often used when more detailed stamp patterns are desired. However, the duration of exposure could vary according to need and circumstances. For example, in some situations, the stamp thickness will be less than the typical 0.120 inches. In such situations, shorter exposure times could be utilized. The objective is to react the photopolymer to approximately the mid-depth point with each exposure.

Numerous other modifications and alternative arrangements may be devised by those skilled in the art without departing from the spirit and scope of the present invention. Notably, while the presently described embodiments are cups and hearts, the principles taught herein can be applied to countless other shapes and designs and the invention is in no way intended to be limited to the specific designs discussed.

Moreover, while the illustrated embodiments depict the partial openings 231, 331 on a single side 250, 350 of the stamp, in certain embodiments and using the techniques discussed herein, there will be partial openings on both sides of the stamp. These partial openings could the same on both sides or different.

In yet other embodiments, the stamp will not include openings that extend through the entirety of the stamp (e.g. 230, 330). Rather the stamp will have only partial openings on both sides (e.g. 231, 331). Such partial openings would be manufactured according to processes as discussed above.

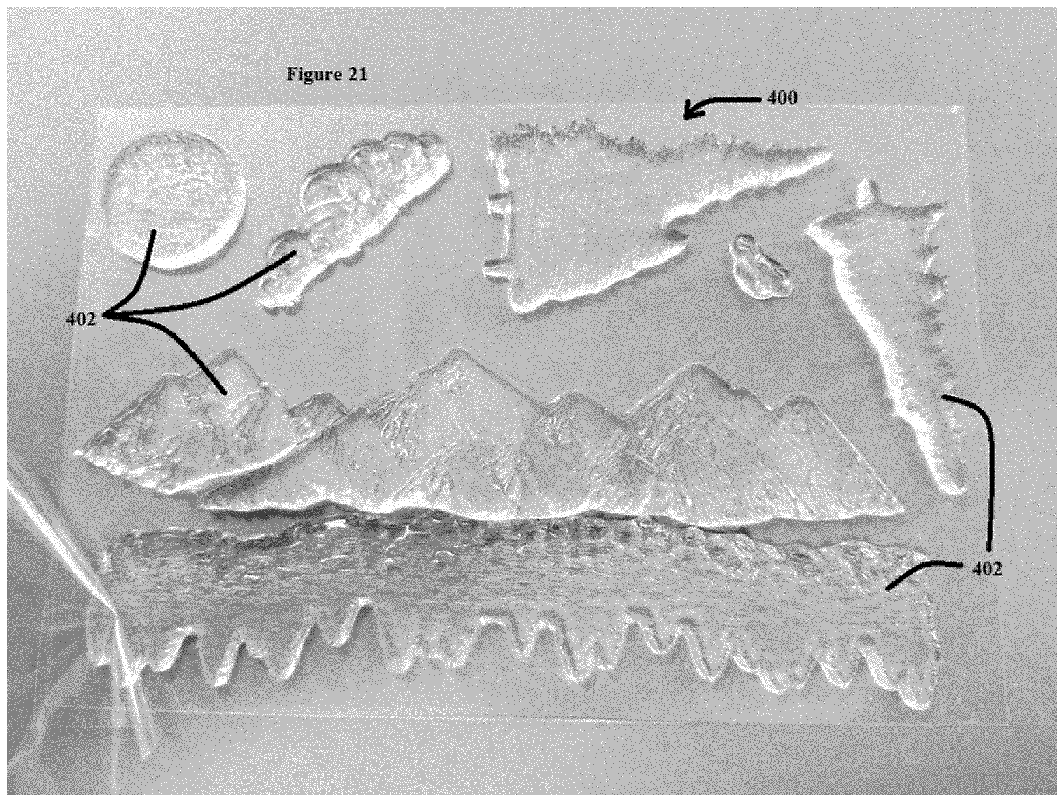

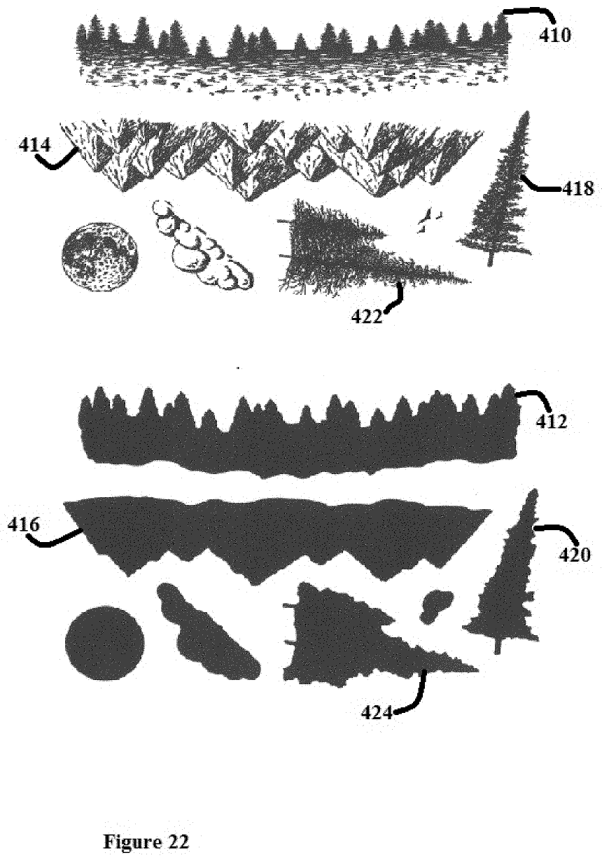

It is also noted that in certain circumstances, the present methodologies could be utilized to manufacture single-sided stamps that have unique properties and allow for unique usage. In particular, the present methods allow for the creation of a stamp having a stamping design on one side with the other side being a plain, flat surface. In some stamping applications, it is desirable to use the detailed side to stamp the image and then use the plain, flat side to add a different color to the image. The stamps made according to the present methods can be made such that they do not have a shoulder. In particular, in some embodiments, a shoulder-less stamp is the result of not using a mask in manufacturing. The plain, flat side stamped image will have an identical but mirrored outline as the detailed stamped side. Examples of the usage of such stamps are illustrated in FIGS. 21 and 22.

FIG. 21 is an illustration of a series of stamps 400 having a stamping surface 402 and, on the side opposite the stamping surface 402, a plain, flat surface. FIG. 22 is an illustration of the imagery created by the respective sides of such a stamp. Notably, image 410 is the image created by the stamping surface 402 side and image 412 is the image created by the plain, flat surface. Similarly, image 414 is the image created by the stamping surface 402 side and image 416 is the image created by the plain, flat surface; image 418 is the image created by the stamping surface 402 side and image 420 is the image created by the plain, flat surface; image 422 is the image created by the stamping surface 402 side and image 424 is the image created by the plain, flat surface; etc. Again, as with all stamps and stamping images discussed herein, the principles taught can be applied to countless other shapes and designs and the invention is in no way intended to be limited to the specific designs discussed.

What is claimed is:

1) A two-sided stamp comprising:
a) a first stamping surface having:
i) a first flat surfaces, wherein the first flat surface is capable of transferring a quantity of ink from an ink source to an article to be stamped; and
ii) a first opening in the first flat surface;
b) a second stamping surface opposite the first stamping surface having:
i) a second flat surface, wherein the second flat surface is capable of transferring a quantity of ink from an ink source to an article to be stamped; and
ii) a second opening in the second flat surfaces.

2) The two-sided stamp of claim 1, wherein the first opening in the first flat surface and the second opening in the second flat surface are a continuous opening extending between the first stamping surface and the second stamping surface.

3) The two-sided stamp of claim 1, wherein the first opening in the first flat surface and the second opening in the second flat surface are one or more items selected from the group consisting of grooves and holes.

4) The two-sided stamp of claim 2, further comprising one or more partial non-continuous openings on the first stamping surface.

5) The two-sided stamp of claim 1, wherein the first flat surface and the second flat surface are tacky.

6) A method of creating mirrored stamp images comprising the steps of:
a) providing a two-sided stamp comprising:
a first stamping surface having:
i) one or more first flat surfaces, wherein the one or more first flat surfaces are capable of transferring a first quantity of ink from an ink source to an article to be stamped; and
ii) one or more first openings in the one or more first flat surfaces; and
a second stamping surface having:
i) one or more second flat surfaces, wherein the one or more second flat surfaces are capable of transferring a second quantity of ink from an ink source to an article to be stamped; and
ii) one or more second openings in the one or more second flat surfaces;
b) applying the first quantity of ink to the one or more first flat surfaces;
c) applying the first stamping surface to the article to be stamped, whereby the one or more first flat surfaces deposits the first quantity of ink on the article to be stamped;
d) applying the second quantity of ink to the one or more second flat surfaces;
e) applying the second stamping surface to the article to be stamped, whereby the one or more second flat surfaces deposits the second quantity of ink on the article to be stamped.

7) The method of claim 6, wherein the first quantity of ink deposited on the article to be stamped and the second quantity of ink deposited on the article to be stamped are mirrored stamp images.

8) The method of claim 6, wherein the first quantity of ink deposited on the article to be stamped and the second quantity of ink deposited on the article to be stamped are different stamp images.

9) The method of claim 6, wherein the one or more first openings in the one or more first flat surfaces and the one or more second openings in the one or more second flat surfaces are continuous openings extending between the first stamping surface and the second stamping surface.

10) The method of claim 6, wherein the one or more first openings in the one or more first flat surfaces and the one or more second openings in the one or more second flat surfaces are grooves.

11) The method of claim 6, wherein the one or more first openings in the one or more first flat surfaces and the one or more second openings in the one or more second flat surfaces are holes.

12) A method of manufacturing a two-sided stamp comprising the steps of:
placing a first negative over a first UV light source, wherein the first negative has a first UV-permeable section and a first UV-impermeable section;
placing a protective film over the first negative;
depositing a liquid photopolymer over the protective film;
placing a substrate over the liquid photopolymer;
placing a second negative over the substrate, wherein the second negative has a second UV-permeable section and a second UV-impermeable section;
placing a second UV light source over the second negative;
illuminating the first UV light source such that it emits a first UV light that passes through the first UV-permeable section of the first negative and reacts the liquid photopolymer causing a first portion of the liquid photopolymer to harden to a first stampable surface;
illuminating the second UV light source such that it emits a second UV light that passes through the second UV-permeable section of the second negative and reacts the liquid photopolymer causing a second portion of the liquid photopolymer to harden to a second stampable surface leaving a third unreacted portion of the liquid photopolymer; whereby the first stampable surface and the second stampable surface form the two-sided stamp.

13) The method of claim 12 further comprising the step of removing the third unreacted portion of the liquid photopolymer.

14) The method of claim 13 wherein the third unreacted portion of the liquid photopolymer is removed using a reclaim board.

15) The method of claim 12 further comprising the step of washing the two-sided stamp a first time.

16) The method of claim 15 further comprising the step of washing the two-sided stamp a second time.

17) The method of claim 12, wherein the first stampable surface and the second stampable surface create mirrored stamp images.

18) The method of claim 12, wherein the first stampable surface and the second stampable surface create different stamp images.
